(19) United States
(12) Patent Application Publication
(10) Pub. No.: US 2003/0077347 A1
(43) Pub. Date: Apr. 24, 2003

(54) Head for coextruding a thermoplastic parison

(75) Inventor: Klaus Miebach, Siegburg (DE)

Correspondence Address: THE FIRM OF KARL F ROSS, 5676 RIVERDALE AVENUE, PO BOX 900, RIVERDALE (BRONX), NY, 10471-0900, US

(73) Assignee: FISCHER-W. MULLER BLASFORMTECHNIK GmbH

(21) Appl. No.: 09/731,072

(22) Filed: Dec. 6, 2000

(30) Foreign Application Priority Data
Dec. 10, 1999 (DE) 19959482.1

(51) Int. Cl. B29C 47/06

(52) U.S. Cl. 425/133.1; 425/381; 425/466

(57) ABSTRACT

An extruder head has inner, middle, and outer annular outlets centered on a common axis and immediately adjacent one another, a flow splitter on the axis, first and second inlets axially upstream in an axial flow direction of the splitter, and a third inlet between the splitter and the outlets. A tubular inner passage centered on the axis extends in the direction from the first inlet around the splitter to the outer outlet and a tubular middle passage centered on the axis extends axially in the direction from the second inlet around the splitter to the middle outlet. An outer passage having an upstream portion axially downstream of the splitter extends transversely of the axis. A tubular downstream portion also axially downstream of the splitter extends coaxially around the inner and middle passages from the upstream portion to the outer outlet.

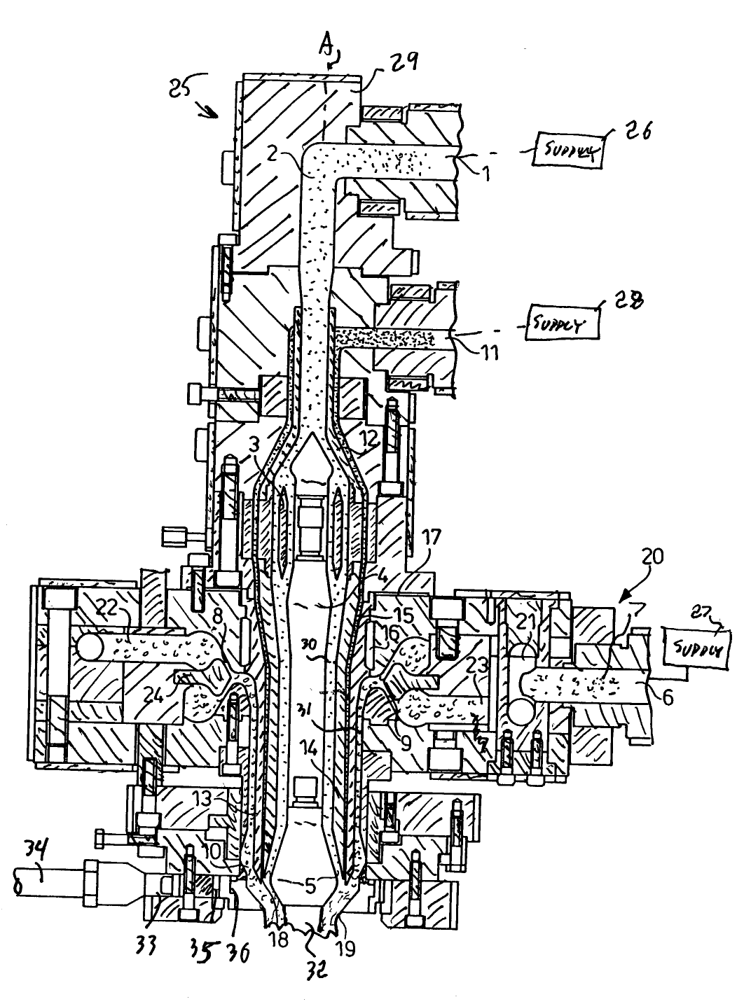

### FIELD OF THE INVENTION

The present invention relates to a coextrusion apparatus. More particularly this invention concerns a coextruder for producing a three-layer parison suitable for blow molding.

### BACKGROUND OF THE INVENTION

An extrusion head for making a hollow thermoplastic parison that is formed to at least two different tubes of different resins has at least three melt inputs. The first plastic melt is fed from a first input in a first direction along a first path past a divider into a first ring nozzle which determines its thickness. At least a second plastic melt from a second input flows along a second path mainly in a second direction transverse to the first direction to a second ring nozzle coaxial with the first ring nozzle. Only immediately upstream of the two ring nozzles are the two flow directions parallel to each other. The first melt can be split into two flows fed to first and third ring nozzles flanking the second ring nozzle. The two- or three-layer parison thus produced is then enclosed in a blow mold and inflated to the desired shape.

This extrusion process can be continuous or discontinuous, the latter also being termed batch operation. In the case of plastics such as polycarbonate or polyamide that are of low viscosity when molten, discontinuous or batch operation is used. To this end the material which is continuously emitted by the plastifying extruder is fed to a chamber from which it is periodically pumped from the nozzle or die and then rapidly spread to the finished product. Higher-viscosity resins such as polyethylene or polypropylene are continuously extruded and are easier to deal with after leaving the nozzle.

Such an coextrusion process can be of the standard type or of the sequential type. In the standard operational mode all the nozzles open at substantially the same location so that the tubes that are emitted by them are joined immediately as they are formed. In the sequential mode one tube is extruded and then another is extruded around it, normally after some cooling and curing of at least one of the tubes before it contacts the other. The latter process is used when resins of different hardnesses or viscosities must be joined together and/or where one resin tube might emerge from its nozzle so hot as to completely melt the other resin, so that it is cooled somewhat before being joined to the other tube of lower melting point.

U.S. Pat. No. 4,717,156 of Motonaga describes a system for making a three-layer parison where the inner and outer layers are the same support resin and the middle layer is a different barrier or adhesive resin. The support resin is injected into the nozzle assembly and split into two coaxial annular flows. The barrier or adhesive resin is injected near the nozzle outlet from the side into the nozzle assembly and is shaped into a tubular flow between the inner and outer flows, and all three flows leave the nozzle at substantially the same location to bond together.

A problem with these systems is that at least two different resins are being extruded from the same nozzle assembly, since if all the resins were the same there would be no point in forming them into separate layers. The different resins normally have different viscosities at different temperatures, so extruding them together is difficult since their close proximity in the nozzle normally means they will all be at the same temperature, which might make one of the resins to viscous or another too runny.

### OBJECTS OF THE INVENTION

It is therefore an object of the present invention to provide an improved coextruder.

Another object is the provision of an improved coextruder head which overcomes the above-given disadvantages, that is which can make a parison of different resins by means of a simple nozzle assembly while taking into account the different thermal requirements of the various resins.

### SUMMARY OF THE INVENTION

An extruder head according to the invention has inner, middle, and outer annular outlets centered on a common axis and immediately adjacent one another, a flow splitter on the axis, first and second inlets axially upstream in an axial flow direction of the splitter, and a third inlet between the splitter and the outlets. A tubular inner passage centered on the axis extends in the direction from the first inlet around the splitter to the inner outlet and a tubular middle passage centered on the axis extends axially in the direction from the second inlet around the splitter to the middle outlet. A separating element is provided upstream of the splitter between the inner and middle passages. An outer passage has an upstream portion axially downstream of the splitter extending transversely of the axis and a tubular downstream portion also axially downstream of the splitter but extending coaxially around the inner and middle passages from the upstream portion to the outer outlet.

In accordance with the invention the extruder head further has a pair of coaxial insulating sleeves centered on the axis downstream of the splitter, flanking the middle passage, and separating the middle passage from the inner and outer passages. These sleeves allow the head to be used both for standard coextrusion and sequential coextrusion, as it is possible to maintain the melts at different temperatures.

The separating element according to the invention is a sleeve centered on the axis. In addition the head has a housing defining the inlets, outlets, and passages and having parts upstream of the splitter, parts downstream of the splitter, and structure insulating the upstream parts from the downstream parts. Thus the outer resin can easily be maintained at a temperature well above or below that of the middle and inner resins. This structure is at least one air gap.

The outer-passage upstream portion is subdivided into two subpassages opening diametrically offset from each other relative to the axis into the outer-passage downstream portion. These subpassages are annular, centered on the axis, and spaced apart along the axis. Means is provided for varying flow rates from the third inlet into the two subpassages.

According to the invention supplies connected to the inlets feed molten resin thereto in batches.

A fourth annular outlet can be provided centered on the common axis outside the outer outlet and connected via a fourth passage to the fourth outlet

### BRIEF DESCRIPTION OF THE DRAWING

The above and other objects, features, and advantages will become more readily apparent from the following description, reference being made to the accompanying drawing whose sole FIGURE is a sectional and partly schematic view of the coextruding apparatus according to the invention.

### SPECIFIC DESCRIPTION

As seen in the drawing a nozzle assembly 25 has a housing 29 formed with three inlets 1, 6, and 11 connected to respective diagrammatically illustrated supplies 26, 27, and 28 which may be of the discontinuous type shown in above-cited U.S. Pat. No. 4,717,326. The first inlet 1 opens into a passage 2 centered on an axis A and extending as a tubular flow 30 through a splitter support 3 carrying a central torpedo or splitter 4 so that the flow 30 exits at an inner annular nozzle 5. Flow from the second inlet 11 moves as a tubular axial flow 15 around a tubular guide 12 whose inner wall delimits the outer surface of the flow 30 from the first inlet 1 and moves down to an outlet nozzle 18 between the nozzles 5 and 10. Flow 7 from the third inlet 6 opens into a passage 21 which splits into two axially offset distributor passages 22 and 23 flanking a splitter 24 that forms them into two radially inward flows 8 and 9 that join to form a tubular outer flow 31 centered on the axis A and ending at a nozzle 10 outward of the nozzle 5. Thus this flow 7 will be, as a result of its being split, redirected, and rejoined, formed into a smooth tube. All the flows 15, 30, and 31 are united at an outlet 19 to a common parison P.

The flows 31 and 15 are separated by an insulating sleeve 13 downstream of the splitter support 3 and the flows 30 and 31 by another such insulating sleeve 14, both made, for instance, of a steel that conducts heat poorly. In addition air spaces 16 and 17 between downstream extruder-head parts 20 roughly level with the splitter 3 separate these parts 20 from the rest of the housing 25. Thus in the critical downstream region of the nozzle 25 the temperatures of the inner and outer flows 30 and 31 can be substantially different from that of the middle flow 15, allowing different resins with different thermal requirements to be handled easily by the coextruder.

When used for three-layer coextrusion the tubular melt issuing from the inner nozzle 5 is a barrier layer and the resin issuing from the outer nozzle 10 is a support layer, while the melt issuing from the middle nozzle 18 is of a resin that bonds well with the two layers 30 and 31 flanking it. The middle flow 15 can be eliminated in a two-layer system.

The drawing also shows a fourth inlet 33 connected to a supply fitting 34 and connected through a fourth passage 35 to an annular outlet or nozzle 36. This allows a four-layer parison P to be extruded.

I claim:

1. An extruder head having
inner, middle, and outer annular outlets centered on a common axis and immediately adjacent one another;
a flow splitter on the axis;
first and second inlets axially upstream in an axial flow direction of the splitter;
a third inlet between the splitter and the outlets;
a tubular inner passage centered on the axis and extending in the direction from the first inlet around the splitter to the inner outlet;
a tubular middle passage centered on the axis and extending axially in the direction from the second inlet around the splitter to the middle outlet;
a separating element upstream of the splitter between the inner and middle passages; and
an outer passage having an upstream portion axially downstream of the splitter and extending transversely of the axis and a tubular downstream portion also axially downstream of the splitter extending coaxially around the inner and middle passages from the upstream portion to the outer outlet.

2. The extruder head defined in claim 1 wherein the head further has
a pair of coaxial insulating sleeves centered on the axis downstream of the splitter and separating the middle passage from the inner and outer passages.

3. The extruder head defined in claim 1 wherein the separating element is a sleeve centered on the axis.

4. The extruder head defined in claim 1 wherein the head has a housing defining the inlets, outlets, and passages and having
parts upstream of the splitter,
parts downstream of the splitter, and
structure insulating the upstream parts from the downstream parts.

5. The extruder head defined in claim 5 wherein the structure is at least one air gap.

6. The extruder head defined in claim 1 wherein the outer-passage upstream portion is subdivided into two subpassages opening diametrically offset from each other relative to the axis into the outer-passage downstream portion.

7. The extruder head defined in claim 6 wherein the two subpassages are annular, centered on the axis, and spaced apart along the axis.

8. The extruder head defined in claim 7, further comprising means for varying flow rates from the third inlet into the two subpassages.

9. The extruder head defined in claim 1, further comprising
supply means connected to the inlets for feeding molten resin thereto in batches.

10. The extruder head defined in claim 1, further comprising
a fourth annular outlet centered on the common axis outside the outer outlet; and
a fourth passage opening into the fourth outlet
